(19) United States
(12) Patent Application Publication
(10) Pub. No.: US 2007/0159851 A1
(43) Pub. Date: Jul. 12, 2007

(54) Surface light source using light emitting diode and liquid crystal display backlight unit employing the same

(75) Inventors: Hyun Ho Lee, Suwon (KR); Jae Wook Kwon, Seoul (KR); Myoung Bo Park, Seocheon-Gun (KR); Hyeong Won Yun, Yongin (KR); Yoon Tak Yang, Hwasung (KR)

Correspondence Address: MCDERMOTT WILL & EMERY LLP, 600 13TH STREET, N.W., WASHINGTON, DC, 20005-3096, US

(73) Assignee: SAMSUNG ELECTRO-MECHANICS CO., LTD.

(21) Appl. No.: 11/651,499

(22) Filed: Jan. 10, 2007

(30) Foreign Application Priority Data
Jan. 10, 2006 (KR) 10-2006-0002842

(51) Int. Cl. F21V 7/04

(52) U.S. Cl. 362/613

(57) ABSTRACT

A surface light source capable of reducing color stains with reduced number of light emitting diodes and manufactured at low costs, and a liquid crystal display backlight unit employing the same. The surface light source includes a plurality of light source clusters arrayed along first and second directions, each of the clusters including three light emitting diodes disposed in a triangular arrangement, the three light emitting diodes including green, red and blue light emitting diodes. The surface light source also includes a first array of the clusters lined along and inverted alternately about the first direction; and a second array of the clusters lined along and inverted alternately about the second direction, where the first array is perpendicular to the second array. The invention reduces color stains to achieve uniform white light and reduces the number of light emitting diodes to manufacture a product at low costs.

### CLAIM OF PRIORITY

This application claims the benefit of Korean Patent Application No. 2006-0002842 filed on Jan. 10, 2006, in the Korean Intellectual Property Office, the disclosure of which is incorporated herein by reference.

### BACKGROUND OF THE INVENTION

1. Field of the Invention

The present invention relates to a surface light source using Light Emitting Diode (hereinafter, LED), for reducing color stains and a Liquid Crystal Display (hereinafter, LCD) backlight unit employing the same. More particularly, the invention relates to a surface light source in which LEDs are disposed in clusters of triangular arrangements alternately inverted, thereby significantly reducing color stains and allowing use of fewer LEDs to reduce the manufacturing costs and an LCD backlight unit employing the same.

2. Description of the Related Art

Cold Cathode Fluorescent Lamps (CCFLs) are prone to environmental pollution with use of mercury gas, slow in response rate, have low color reproducibility and are unsuitable for miniaturization of LCD panels.

On the contrary, LEDs are environmentally friendly, capable of high speed response in nanoseconds, effective for video signal stream, capable of impulsive driving and has a color reproducibility of 100%. In addition, the light amounts of red, green and blue LEDs can be adjusted to control luminance, color temperature and the like. The LEDs are also suitable for miniaturization of LCD panels. Thus, the LEDs are actively employed as a light source for backlights of LCD panels and the like.

The LCD backlight adopting the LED can be categorized into a side edge type and a direct type depending on the location of the light source. In the side edge type backlight, a bar-shaped light source is located at a side to irradiate light through a light guide panel. In the direct type backlight, a surface light source having an area almost the same as the LCD panel is placed under the LCD panel to irradiate light to the plane of the LCD panel.

As shown in FIG. 1(a), in order to mix red, green and blue lights to generate white light, a surface light source 200 used in a direct type LCD panel according to the prior art includes a plurality of 2×2 LED matrixes 205 arranged in lines and rows, each composed of red and blue LEDs disposed in one diagonal direction and two green LEDs disposed in the other diagonal direction.

In the drawings, the reference sign ‘R’ represents a red LED emitting red light, the reference sign ‘G’ represents a green LED emitting green light and the reference sign ‘B’ represents a blue LED emitting blue light. In general, in order to generate white light, two green LEDs, one red LED and one blue LED are adopted.

FIG. 1(b) illustrates the LED arrangement of the conventional surface light source 200 including a plurality of LED matrixes 205 arranged in lines and rows. In the LED arrangement shown in FIG. 1(b), red, green and blue lights are relatively well mixed to generate uniform white light in a central portion of the light source 200. Nonetheless, the blue or red LEDs are not properly disposed in corners 211 and 212 of the surface light source, thus emitting reddish or bluish light.

That is, as shown in FIG. 1(b), in the corner denoted by 211, only the red LED R and the green LED G are arranged alternately without a blue LED B, and thus reddish light is emitted. In the corner denoted by 212, only the blue LED B and the green LED G are alternately arranged without a red LED R, and thus bluish light is emitted.

Therefore, the surface light source 200 with the above LED arrangement according to the prior art has a problem of non-uniform emission of white light in the corners 211 and 212 thereof.

As an approach to overcome such a problem, another LED arrangement of a surface light source 300 according to the prior art is shown in FIG. 2. In the surface light source 300 shown in FIG. 2, a plurality of LEDs are repeatedly arranged in a first row 310 in the order of blue, green, green and red. In a second row 320 adjacent to the first row, a plurality of LEDs are arranged repeatedly in a row in the order of green, red, blue and green. In a third row 330, the LEDs are arranged in the order of green, blue, red and green, and in a fourth row 340, the LEDs are arranged in the order of red, green, green and blue. These rows are disposed repeatedly.

In this surface light source 300, green, red, blue and green LEDs are disposed in corners 311 and 312 to generate relatively uniform white light. However, there exist portions 315 where four green LEDs are clustered in the central part of the surface light source 300. Thus, green light is dominant in these portions 315, resulting in color stains.

As a result from conducting light simulation with the surface light source 300 with the above LED arrangement indicates, green light, which is perceived sensitively by human, is predominant, resulting in color stains on the surface light source.

Therefore, the conventional surface light source 30 and the LCD backlight unit employing the same result in a non-uniform distribution of white light with the color stains.

To overcome such a drawback of color stains, the assignee of the present invention has suggested another approach in Korea Patent Application No. 2005-0062297.

This conventional technology by the assignee of the present invention includes a first LED array 410 with repetition of two consecutive green LEDs, one red LED and one blue LED, and a second array 420 with repetition of two consecutive green LEDs, one blue LED and one red LED. The first and second LED arrays are arranged in lines and rows such that two green LEDs are surrounded by red or blue LEDs.

Therefore, as shown in FIG. 4, the conventional surface light source 400 described above has red, green and blue LEDs in such a way that two green LEDs are surrounded by red or blue LEDs. This allows uniform white light without the color stains in the corners of the surface light source 400 as well as the central portion of the surface light source 400. In addition, this conventional technology allows the surface light source 400 to emit white light similar to the color map of human, reducing the color stains to attain uniform white light.

However, in this conventional technology, a cluster is composed of two adjacent green LEDs, one red LED and one blue LED, i.e., a unit of B, G, G and R LEDs, thus requiring a large number of LEDs per unit area of the surface light source 400. Therefore, the conventional technology still leaves a room for realizing a surface light source at lower costs.

### SUMMARY OF THE INVENTION

The present invention has been made to solve the foregoing problems of the prior art and therefore an aspect of the present invention is to provide a surface light source using light emitting diode, capable of reducing color stains to generate uniform white light, and a liquid crystal display backlight unit employing the same.

Another aspect of the invention is to provide a surface light source using light emitting diode, which uses fewer light emitting diodes per unit area thereof and reduces color stains to achieve excellent white light.

According to an aspect of the invention, the invention provides a surface light source for reducing color stains. The surface light source includes: a plurality of light source clusters arrayed along first and second directions, each of the clusters including three light emitting diodes disposed in a triangular arrangement, the three light emitting diodes including green, red and blue light emitting diodes; a first array of the clusters lined along and inverted alternately about the first direction; and a second array of the clusters lined along and inverted alternately about the second direction, the first array being perpendicular to the second array.

According to an embodiment of the present invention, the triangular arrangement has equal inner angles.

According to an embodiment of the present invention, the triangular arrangement has different inner angles.

According to an embodiment of the present invention, the triangular arrangement has two equal inner angles.

Preferably, the triangular arrangement has inner angles respectively equal to those of the triangular arrangement of an adjacent one of the clusters.

Preferably, the clusters of the same type have a pitch in the range represented by D≦2H with respect to a height from a reflective sheet to a diffusion sheet in a backlight unit for a liquid crystal display.

According to another aspect of the invention, the invention provides a liquid crystal display backlight unit attached to a liquid crystal display panel. The liquid crystal display backlight unit includes: a plurality of light source clusters arrayed along first and second directions, each of the clusters including three light emitting diodes disposed in a triangular arrangement, the three light emitting diodes including green, red and blue light emitting diodes, a first array of the clusters lined along and inverted alternately about the first direction, and a second array of the clusters lined along and inverted alternately about the second direction, the first array being perpendicular to the second array; a diffusion sheet for uniformly diffusing the light incident from the surface light source; and a light collecting sheet for collecting the light diffused by the diffusion sheet.

### BRIEF DESCRIPTION OF THE DRAWINGS

The above and other aspects, features and other advantages of the present invention will be more clearly understood from the following detailed description taken in conjunction with the accompanying drawings, in which:

FIG. 1(a) is a schematic view illustrating an LED matrix used in a conventional surface light source, and FIG. 1(b) is a schematic view illustrating an arrangement of the LED matrixes shown in FIG. 1(a);

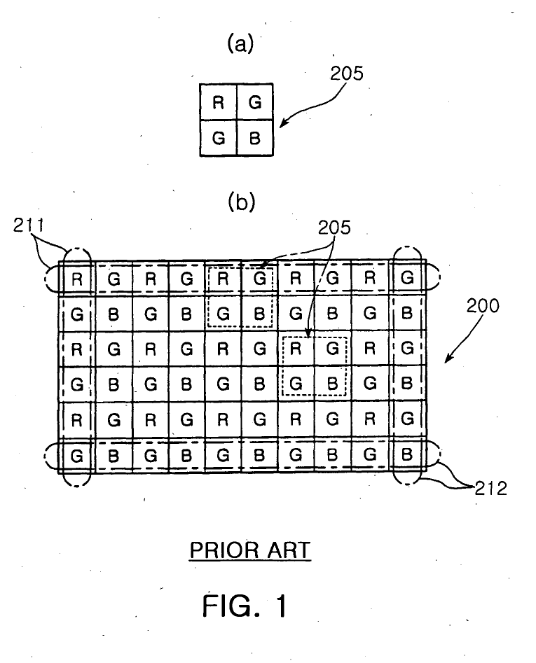

FIG. 2 is a view illustrating an arrangement of LEDS of another conventional surface light source;

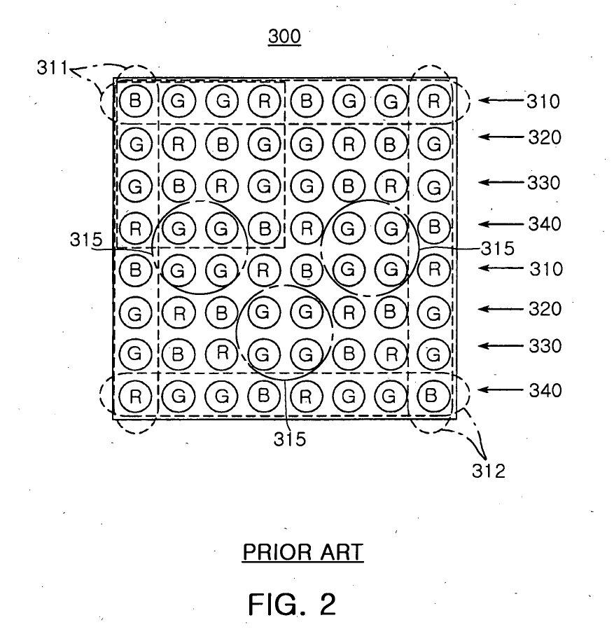

FIG. 3 is a view illustrating R, G, G and B arrangement of LEDs of further another conventional surface light source;

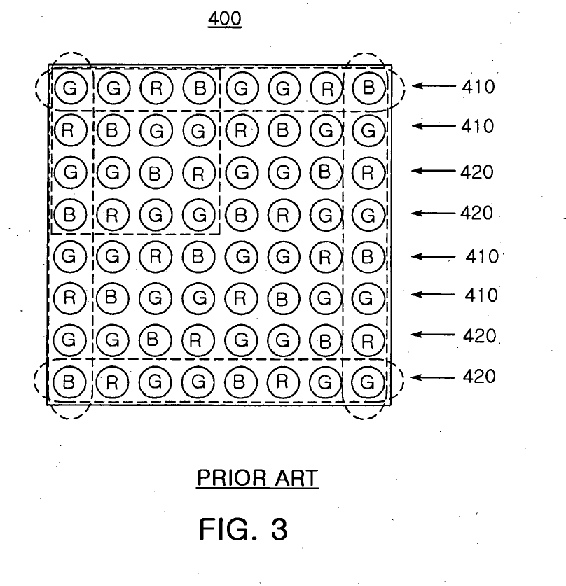

FIG. 4 is a picture showing the white light with color stains in an LCD backlight unit employing the surface light source having the R, G, G and B arrangement;

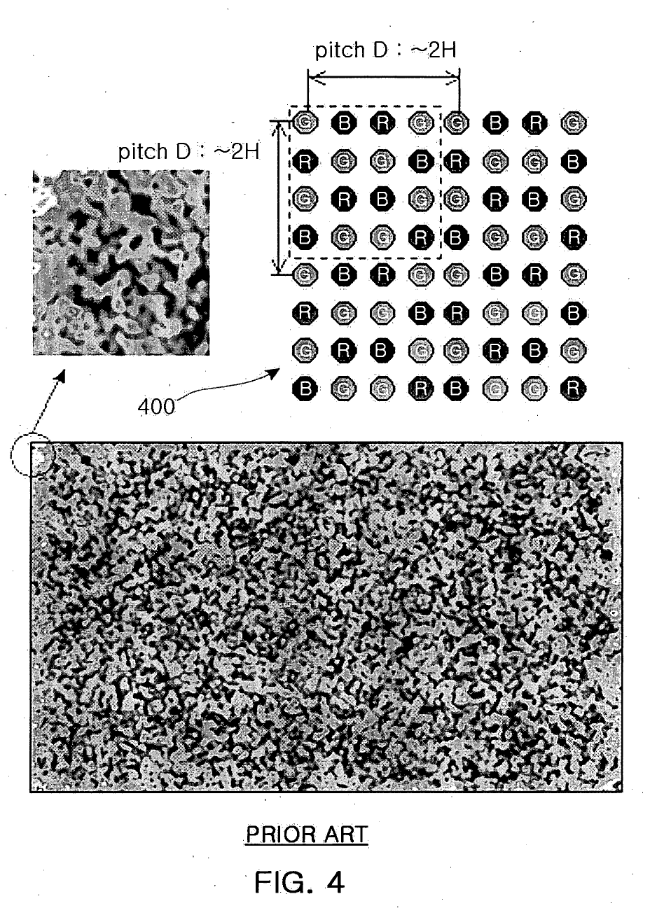

FIG. 5 is a view illustrating a surface light source having triangular clusters of LEDs according to a first embodiment of the present invention;

FIG. 6 is a picture showing white light with color stains in the LCD backlight unit employing the surface light source according to the first embodiment of the present invention;

FIG. 7 is a view illustrating a surface light source with triangular clusters of LEDs according to a second embodiment of the present invention;

FIG. 8 is a picture showing white light with color stains in the LCD backlight unit employing the surface light source according to the second embodiment of the present invention;

FIG. 9 is a view illustrating the correlation between a pitch between the clusters in the surface light source of the present invention and a height of a diffusion sheet from a reflective sheet; and

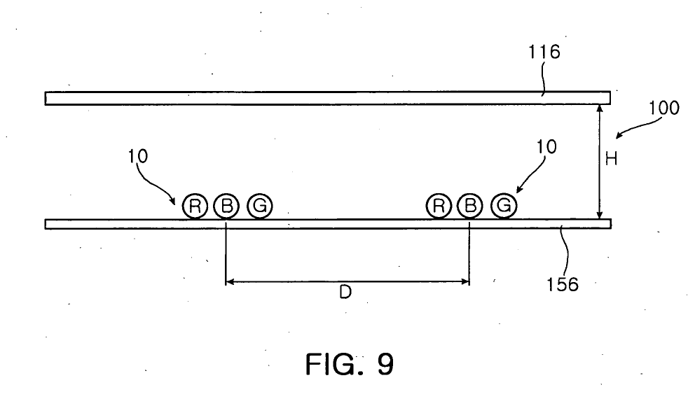

FIG. 10 is an exploded view illustrating an LCD backlight unit employing the surface light source according to the present invention.

### DETAILED DESCRIPTION OF THE PREFERRED EMBODIMENT

Exemplary embodiments of the present invention will now be described in detail with reference to the accompanying drawings.

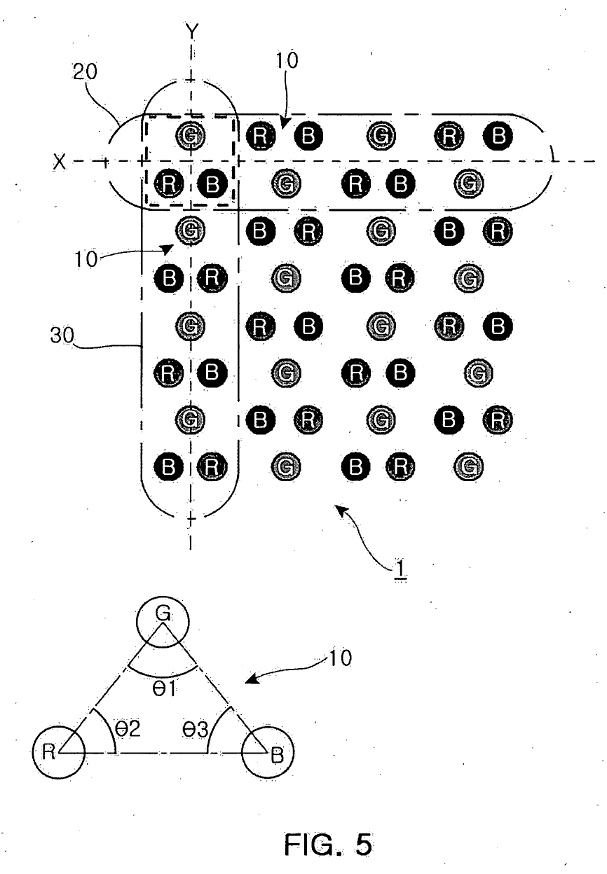

As shown in FIG. 5, a surface light source 5 using LED and for reducing color stains includes a plurality of light source clusters 10 arrayed along first and second directions. Each of the light source clusters 10 consists of a green G LED, a red R LED and a blue B LED disposed in a triangular arrangement. The surface light source 5 also includes a first array 20 of the clusters 10 lined along and inverted alternately about the first direction.

As shown in FIG. 5, the x-axis is assumed as the first direction and the y-axis is assumed as the second direction.

Thus, the plurality of light source clusters 10 disposed in the first array 20 are lined along and inverted alternately about the first direction of the x-axis.

Therefore, given that a first cluster 10 has G at the top and R and B at the bottom, a second cluster 10 has R and B at the top and G at the bottom. And a third cluster 10 has G at the top and R and B at the bottom and a fourth cluster 10 has R and B at the top and G at the bottom.

On the other hand, the surface light source 5 also includes a second array 30 of the clusters 10 disposed perpendicular to the first array 20. Each of the clusters 10 of the second array 30 also consists of a green G LED, a red R LED and a blue B LED disposed in a triangular arrangement. The clusters 10 in the second array 30 are lined along and alternately inverted about the second direction.

That is, as shown in FIG. 5, assuming that the Y-axis is the second direction, the plurality of clusters 10 disposed in the second array 30 are lined along and alternately inverted about the second direction.

As shown in FIG. 5, a first cluster 10 in the second array 30 has G at the top and R at the left bottom and B at the right bottom, whereas a second cluster 10 has G at the top and B at the left bottom and R at the right bottom.

A third cluster 10 in the second array 30 has G at the top and R at the left bottom and B at right the bottom in the same manner as the first cluster 10, whereas and a fourth cluster 10 has G at the top and B at the left bottom and R at the right bottom in the same manner as the second cluster 10.

In addition, in the surface light source 1 for reducing color stains, the triangular arrangement of each of the clusters 10 has equal inner angles θ1, θ2 and θ3. In this case, the G, R and B LEDs of each of the clusters 10, which is a basic unit, can be arranged in an equilateral triangle.

In addition, the triangular arrangement of each of the clusters 10 can have different inner angles θ1, θ2 and θ3. In this case, the G, R and B LEDs of each of the clusters 10, which is a basic unit, can be arranged in a general triangle having different inner angles.

Further, according to the present invention, the triangular arrangement of each of the clusters 10 can have two equal inner angles out of the inner angles θ1, θ2 and θ3. In this case, the G, R and B LEDs of each of the clusters 10, which is a basic unit, can be arranged in an isosceles.

In addition, the triangular arrangement of each of the clusters 10 can have inner angles θ1, θ2 and θ3 respectively equal to those θ1, θ2 and θ3 of the triangular arrangement of an adjacent one of the clusters 10. That is, an identical form of triangles is formed by the G, R and B LEDs of each unit cluster 10 lined in the first array 20 and the second array 30.

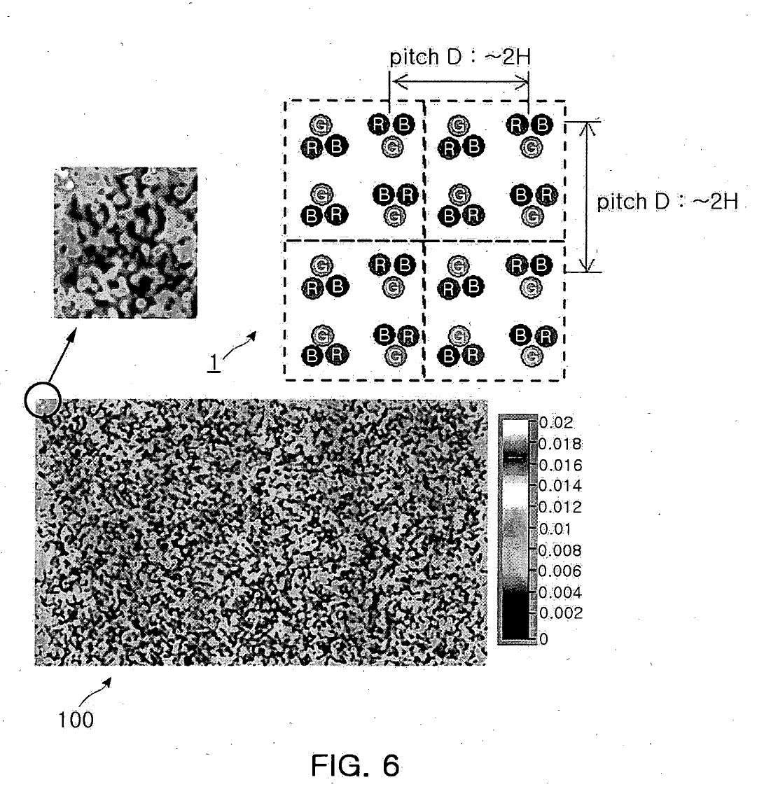

Constituting an LCD backlight unit 100 as shown in FIG. 6, the surface light source 1 according to the present invention with the above-described configuration can reduce color stains to obtain uniform white light. The surface light source 1 using LED according to the present invention has a reduced level of color stains similar to the level by the surface light source 400 taught in Korea Patent Application No. 2005-0062297 filed by the assignee of the present invention, thereby equally achieving a uniform light source.

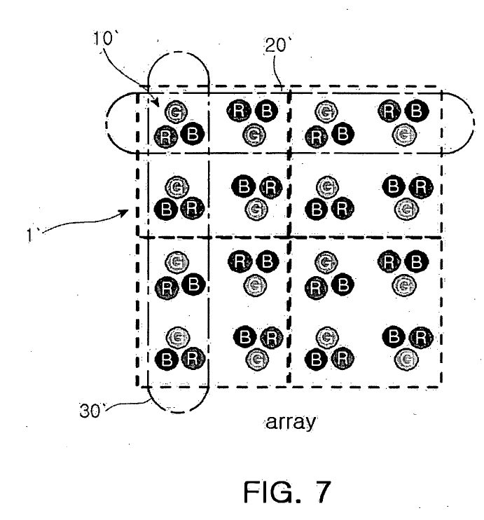

FIG. 7 illustrates another structure of a surface light source 1′ using LED for reducing color stains according to a second embodiment of the present invention.

Such a structure has the first array 20′ and the second array 30, as shown in FIG. 5, but the G, R and B LEDs are arranged more densely from one another in each unit cluster 10′. In addition, each of the clusters 10, is disposed farther from another one of the adjacent clusters 10′ compared to the embodiment shown in FIG. 5.

In this configuration, a pitch D between the clusters 10′ has the range represented by D≦2H with respect to a height H from a reflective sheet 156 to a diffusion sheet 116 in the case where the surface light source constitutes an LCD backlight unit 100. Preferably, a pitch D between the clusters 10 does not exceed 2H because then the distance between the clusters will be too long, resulting in a deficient amount of light between the clusters to cause color stains.

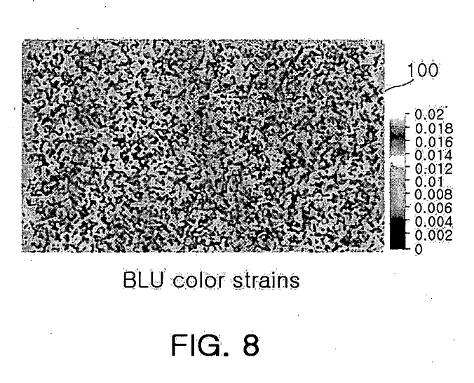

In the case of constituting the LCD backlight unit 100 as shown in FIG. 8, the surface light source 1′ according to the present invention can reduce color stains to obtain uniform white light. The surface light source 1′ achieves a reduced level of color stains similar to the level achieved by the surface light source 400 taught in Korea Patent Application No. 2005-0062297 filed by the assignee of the present invention, thereby equally achieving uniform white light.

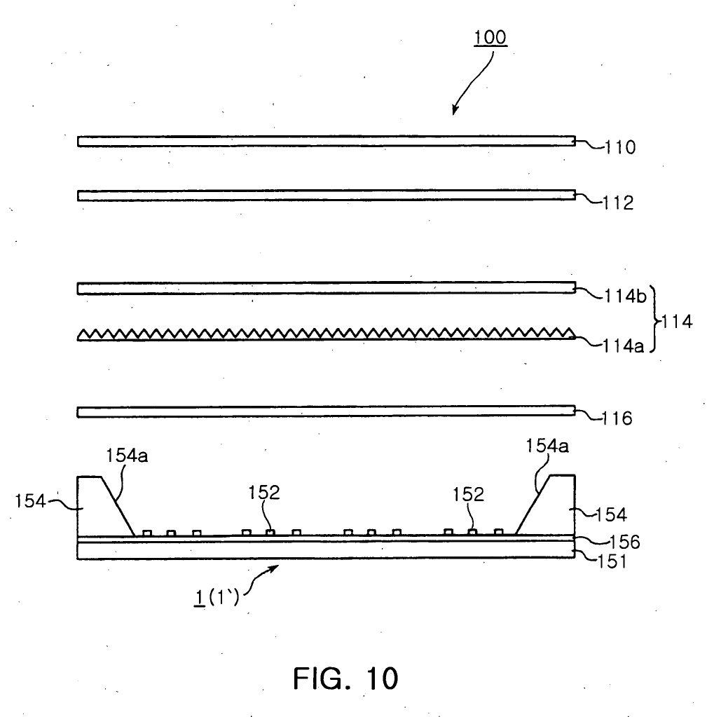

The LCD backlight unit 100 employing the surface light source 1, 1′ for reducing color stains according to the present invention has a structure as shown in FIG. 10.

The LCD backlight unit 100 according to an embodiment of the present invention includes the surface light source 1 according to the present invention and a diffusion sheet 116 for uniformly diffusing the light incident from the surface light source 1.

In addition, the backlight unit 100 also includes at least one light collecting sheet 114 provided above the diffusion sheet 116 at the side of an LCD panel 110 to collect the light, diffused by the diffusion sheet 116, in a direction perpendicular to the plane of the liquid crystal display panel 110.

A pitch D between the clusters 10 provided in the surface light source 1 has the range represented by D≦2H with respect to a height H from the reflective sheet to the diffusion sheet as mentioned above.

In addition, the LCD backlight unit 100 according to the present invention may further include a protective sheet 112 provided above the light collecting sheet 114 to protect optical structures underneath. Moreover, the surface light source 1 includes a substrate 151 and the plurality of LEDs 152 disposed in each of the light source clusters 10 on the substrate 151. In addition, the LCD backlight unit 100 may also include a sidewall 154 surrounding the LEDs disposed in clusters 10 and having an inclined surface facing the LEDs and a reflective sheet 156 provided on the substrate 151 to upwardly reflect the light emitted from the LEDs 152.

In addition, it is preferable that a reflecting material 154a is applied on the inclined surface of the sidewall 154 so as to upwardly reflect the light emitted sideward.

In addition, the diffusion sheet 116 disposed above the surface light source 1 diffuses the light incident from the surface light source 1 to prevent local concentration of the light. Moreover, the diffusion sheet 116 adjusts the direction of the light propagating to the first collecting sheet, thereby reducing the angle of inclination with respect to the first light collecting sheet 114a.

Each of the first light collecting sheet 114a and the second light collecting sheet 114b has a predetermined arrangement of prisms each having a shape of triangular pillar. In addition, the prism arrangement of the first light collecting sheet 114a crosses that of the second light collecting sheet 114b at a predetermined angle (e.g. 90°). The first and second light collecting sheets 114a and 114b serve to collect the light diffused by the diffusion sheet 116 in a direction perpendicular to the plane of the liquid crystal display panel. This allows almost perfect perpendicular incidence of light passed through the first and second light collecting sheets 114a and 114b onto the protective sheet 112.

Thereby, most of the light passed through the first and second light collecting sheets 114a and 114b propagates perpendicularly, allowing uniform luminance distribution.

In the meantime, the present invention is exemplified by using two light collecting sheets as shown in FIG. 10, but only one light collecting sheet can be used in other cases.

The protective sheet 112 provided above the second light collecting sheet 114b not only functions to protect the surface of the second light collecting sheet 114b but also to diffuse light to obtain uniform distribution of light. Also, the LCD panel 110 is installed above the protective sheet 112.

As set forth herein, the LCD backlight unit 100 according to the present invention employs the surface light source 1 according to the present invention to reduce color stains and thereby obtain uniform white light. This allows the LCD backlight unit 100 to have a simplified structure without a light guide panel, etc., achieving light weight and miniaturization and providing a clearer image compared to the conventional LCD backlight unit.

The present invention as set forth above allows a surface light source and an LCD backlight unit employing the same to have reduced color stains and achieve uniform white light with 25% less number of LEDs used therein compared to the conventional arrangement of R, G, G and B LEDs.

Therefore, according to the present invention, the surface light source and the LCD backlight unit employing the same has less number of LEDs per unit area thereof, thus manufactured at low costs while achieving excellent white light.

While the present invention has been shown and described in connection with the exemplary embodiments, it will be apparent to those skilled in the art that modifications and variations can be made without departing from the spirit and scope of the invention as defined by the appended claims.

1. A surface light source comprising:
a plurality of light source clusters arrayed along first and second directions, each of the clusters including three light emitting diodes disposed in a triangular arrangement, the three light emitting diodes including green, red and blue light emitting diodes;
a first array of the clusters lined along and inverted alternately about the first direction; and
a second array of the clusters lined along and inverted alternately about the second direction, the first array being perpendicular to the second array.

2. The surface light source according to claim 1, wherein the clusters of the first array are inverted alternately about a horizontal axis of the first direction.

3. The surface light source according to claim 1, wherein the clusters of the second array are inverted alternately about a vertical axis of the second direction.

4. The surface light source according to claim 1, wherein the triangular arrangement has equal inner angles.

5. The surface light source according to claim 1, wherein the triangular arrangement has different inner angles.

6. The surface light source according to claim 1, wherein the triangular arrangement has two equal inner angles.

7. The surface light source according to claim 1, the triangular arrangement has inner angles respectively equal to those of the triangular arrangement of an adjacent one of the clusters.

8. The surface light source according to claim 1, the clusters of the same type have a pitch in the range represented by D≦2H with respect to a height from a reflective sheet to a diffusion sheet in a backlight unit for a liquid crystal display.

9. A liquid crystal display backlight unit attached to a liquid crystal display panel, comprising:
a plurality of light source clusters arrayed along first and second directions, each of the clusters including three light emitting diodes disposed in a triangular arrangement, the three light emitting diodes including green, red and blue light emitting diodes, a first array of the clusters lined along and inverted alternately about the first direction, and a second array of the clusters lined along and inverted alternately about the second direction, the first array being perpendicular to the second array;
a diffusion sheet for uniformly diffusing the light incident from the surface light source; and
a light collecting sheet for collecting the light diffused by the diffusion sheet.

10. The liquid crystal display backlight unit according to claim 9, wherein the clusters of the same type have a pitch in the range represented by D≦2H with respect to a height from a reflective sheet to the diffusion sheet.
